(19) United States
(12) Patent Application Publication
(10) Pub. No.: US 2006/0235966 A1
(43) Pub. Date: Oct. 19, 2006

(54) Predefined live chat session

(75) Inventors: Scott Rossow, Whippany, NJ (US); Carl Rossow, Denver, CO (US); Joel Benenson, Upper Montclair, NJ (US)

Correspondence Address: DARBY & DARBY P.C., P. O. BOX 5257, NEW YORK, NY, 10150-5257, US

(73) Assignee: iModerate Research Technologies, Denver, CO (US)

(21) Appl. No.: 11/373,842

(22) Filed: Mar. 9, 2006

Related U.S. Application Data
(60) Provisional application No. 60/671,564, filed on Apr. 15, 2005.

(51) Int. Cl. G07G 1/00; G06F 17/30; G06F 15/173

(52) U.S. Cl. 709/224; 705/10

(57) ABSTRACT

Directing qualified respondents into communication with a moderator of a chat session for collection of qualitative information, includes soliciting an audience for participation in an on-line survey which is conducted through a network with one or more client devices, gathering data from the audience during the survey, selecting qualified respondents for one-on-one real time chat sessions from the audience.

### CLAIM OF PRIORITY

This application claims the benefit of priority under 35 U.S.C. § 119(e) to U.S. Provisional Application No. 60/671,564, filed Apr. 15, 2005, titled “LIVE CHAT SESSION PUSH (II),” hereby incorporated by reference in its entirety.

### FIELD OF INVENTION

The present invention relates to electronic surveys, and in particular, to a system and associated method for including sample pool members to the survey in a real-time chat session without disrupting the survey.

### BACKGROUND OF THE INVENTION

On-line market research has traditionally been quantitative in its scope. Inquiries have been limited to true/false, multiple choice and scaled responses. Some on-line research has dabbled in qualitative data by asking open-ended questions. However, these open-ended questions are limited in the amount of data they can retrieve. The answers are taken at face value without any follow-up interrogatory. There is no real-time control of the direction of the answer. Participants tend to move off topic in their responses, and may not fully address the topic.

Some companies have used web-based focus groups in an effort to capture elusive qualitative data. Such focus groups typically consist of 8 to 15 or more people in an on-line chat-room with a live moderator. Occasionally, to populate the focus group, some of the participants will have demographics that differ somewhat from the demographics specified by the list broker or panel company. The moderator will then lead theses persons in a chat through a series of questions and follow-ups designed to solicit qualitative data.

These on-line focus groups lack the focus of an individual opinion. While there is a chance for individual opinions and follow-up, the qualitative data is limited by the need to include the other members of the focus group, not just the individual. In addition, there is a danger of the data being corrupted. As the individuals view the opinions of others, human tendencies toward following the opinions of others tend to corrupt otherwise virgin opinions on the research subject, or so-called “Group Think.” Lastly, getting 8 to 15 people in an on-line chat in real-time and at a time when a moderator is available puts an inherent, and somewhat disguised, limitation on the sample. The sample is limited by availability of the moderator and the other people in the focus group. That very well may skew the sample.

In addition, bulletin board technology can be used to circumvent some of these limitations. Thus, individuals can be recruited to participate in a series of “bulletin board scenarios” in which the moderator posts open-ended questions onto a virtual bulletin board. A selected group of respondents logs onto the board at their individual convenience, and answers the question(s). Follow-up questions may be posted the following day, and a repetition of the “log-on/answer” scenario continues to play out until the researchers are satisfied with the data. A significant limitation of on-line bulletin boards; however, is that the follow-up questions are posted to the entire respondent sample and so the follow-up questions are not tailored to individual responses. In addition, the question and answer exchange happens over the course of days, not in real-time. This allows the respondent time to mull over a question and give a thought-out, well reasoned answer (or none at all), instead of an instant gut reaction. While the bulletin board answers, if provided, may be more succinct, the gut reaction is much closer to the consumer response that marketing personnel covet.

The delay in obtaining responses can also corrupt the data pool. Respondents speak to others who are demographically diverse from a researcher's sample group, in the situation in which their opinions could be influenced or changed by non-sampled people. That could distort the sample pool. At the very least, it greatly decreases the reliability of the gathered data. Accordingly, the on-line market research industry is in need of better tools for collecting qualitative information from individuals without the constraints of prior approaches. The present invention addresses these and other needs.

### SUMMARY OF THE INVENTION

The present invention relates to a system and method for collecting information in real-time during an on-line survey, which is conducted through a network. In accordance with one aspect of the invention, an audience is solicited for participation in the on-line survey, and information is collected from the audience through a network from one or more client devices. Based on such information, qualified respondents are selected from the audience to participate in a one-on-one real-time chat session, and the client devices of the qualified respondents are directed into communication with a moderator of the chat session, where information is collected.

These and other aspects, features, steps and advantages can be further appreciated from the accompanying figures and description of certain illustrative embodiments.

### BRIEF DESCRIPTION OF THE DRAWING FIGURES

FIG. 1 is a flow diagram illustrating steps in accordance with an embodiment of the invention;

FIG. 2 depicts a user interface created by the embodiment shown in FIG. 1 configured for presentation at respondent's terminal;

FIG. 3 depicts a user interface created by the embodiment shown in FIG. 1 configured for presentation at a moderator's terminal;

FIG. 4 illustrates an embodiment of a communication network environment suitable for implementing the present invention.

FIG. 5 depicts a user interface displaying possible questions in a quantitative survey for presentation at an audience member's terminal.

FIG. 6 depicts a user interface of an interactive one-on-one qualitative chat session.

FIG. 7 depicts a user interface created by the embodiment shown in FIG. 1 configured for presentation at respondent's terminal.

### DETAILED DESCRIPTION OF THE ILLUSTRATIVE EMBODIMENTS

By way of overview and introduction, presented and described are embodiments of a system and method for collecting individualized qualitative information, in real-time. In one implementation a proprietary software tool allows one-on-one web-based interviews between persons who have responded to an on-line survey and respective, trained research professionals. Use of a tool in accordance with this aspect of the invention provides qualitative data from a selected audience, in addition to the quantitative data generally obtained in on-line surveys. This sampling methodology allows researchers to simply and effectively reach representative respondent pools or targeted sub-groups within a broader audience. The various embodiments of the present system can be used in a variety of fields in which one-on-one qualitative data is desired, including the commercial market research field.

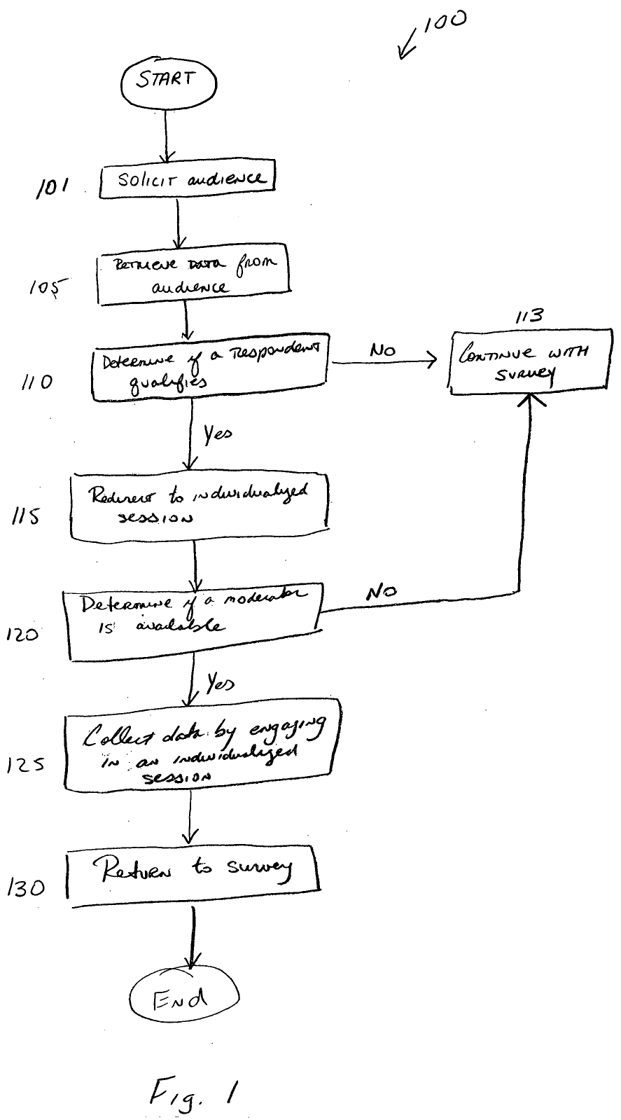

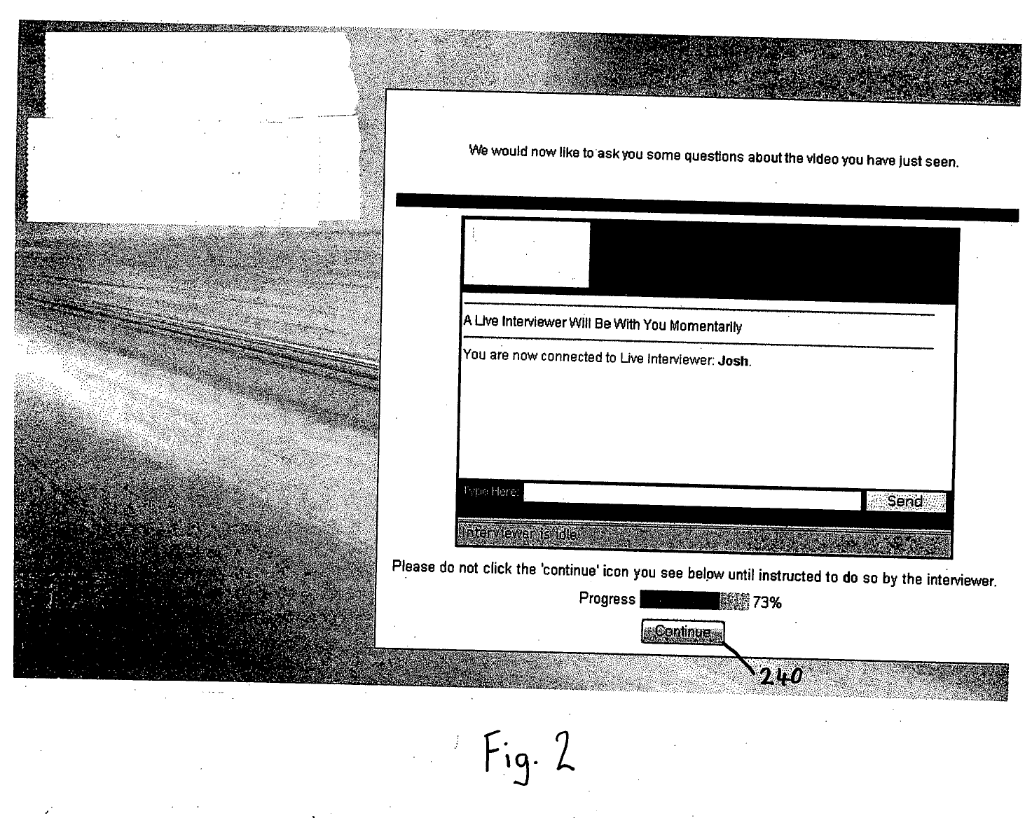

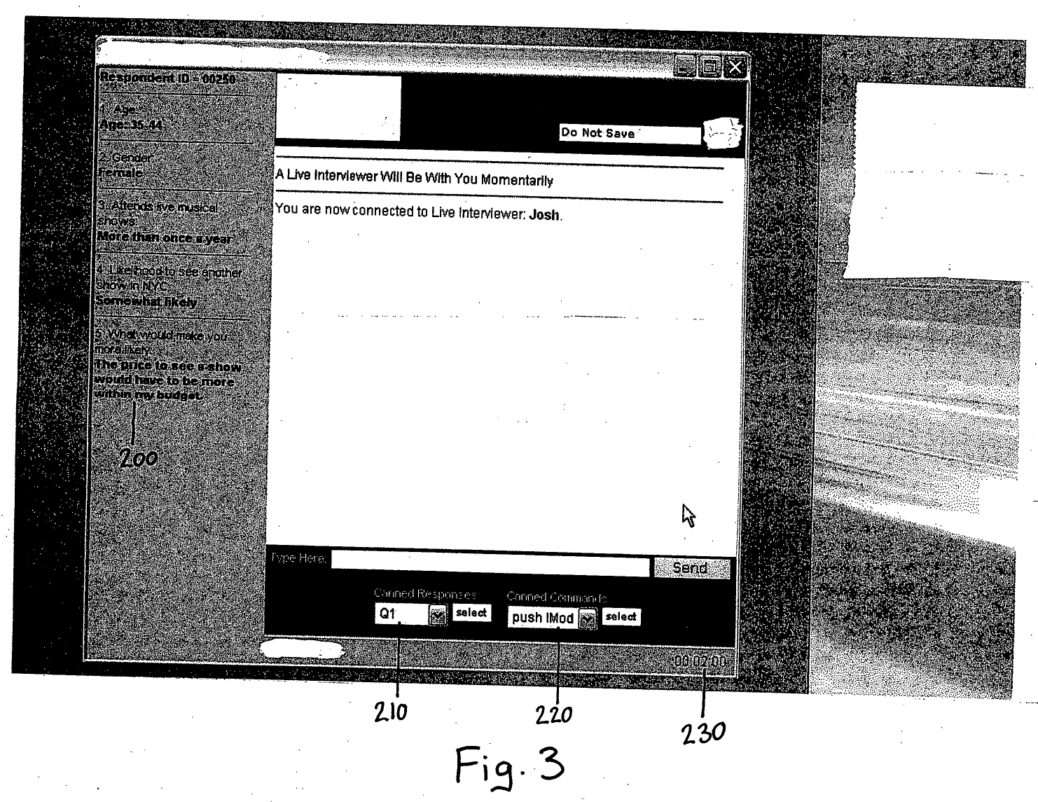

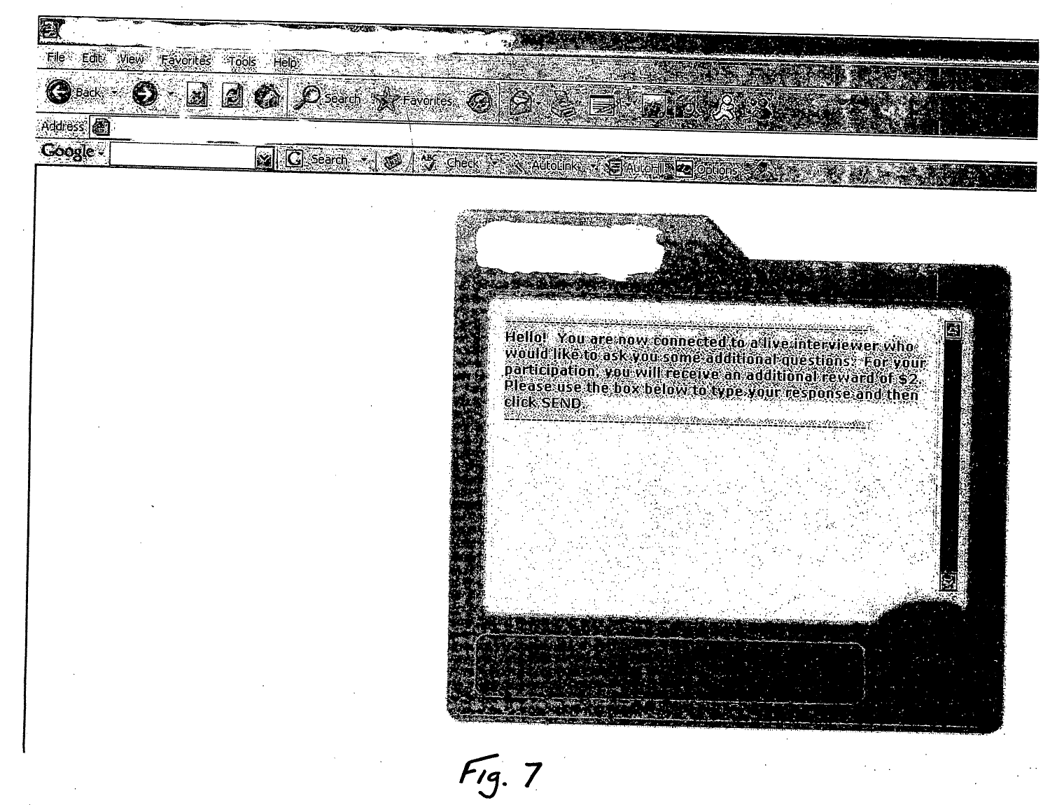

FIG. 1 presents a flow diagram for process 100, which is a method in accordance with an embodiment of the invention. FIG. 1 can be better understood in conjunction with FIGS. 2 and 3. FIG. 2 depicts a user interfaces that can be utilized by respondents undergoing process 100 and FIG. 3 depicts a user interface that can be utilized by a moderator conducting a qualitative session, in accordance with process 100. FIG. 7 also depicts a user interface that can be utilized by respondents undergoing process 100. Through a web-based process, research or data collection companies, as well as the client can select and solicit audiences for participation in on-line quantitative surveys, step 101, programmable using any of today's leading online data collection tools. The selection process can include choosing audiences randomly or based on predetermined factors, such as demographics, age or simply possession of solicitation friendly e-mail addresses. The actual solicitation of the selected audience can occur through the distribution of invitations requesting participation in an on-line survey or through a variety of techniques including bulletin board postings seeking participants for such a survey. Preferably, the invitations are on-line invitations that are sent via the internet to audience computers and include a connection link to a chosen survey. The audience members who choose to participate, also referred to as respondents, can do so by responding to the invitations or postings (e.g., by clicking on the provided link) and then engaging in the on-line survey.

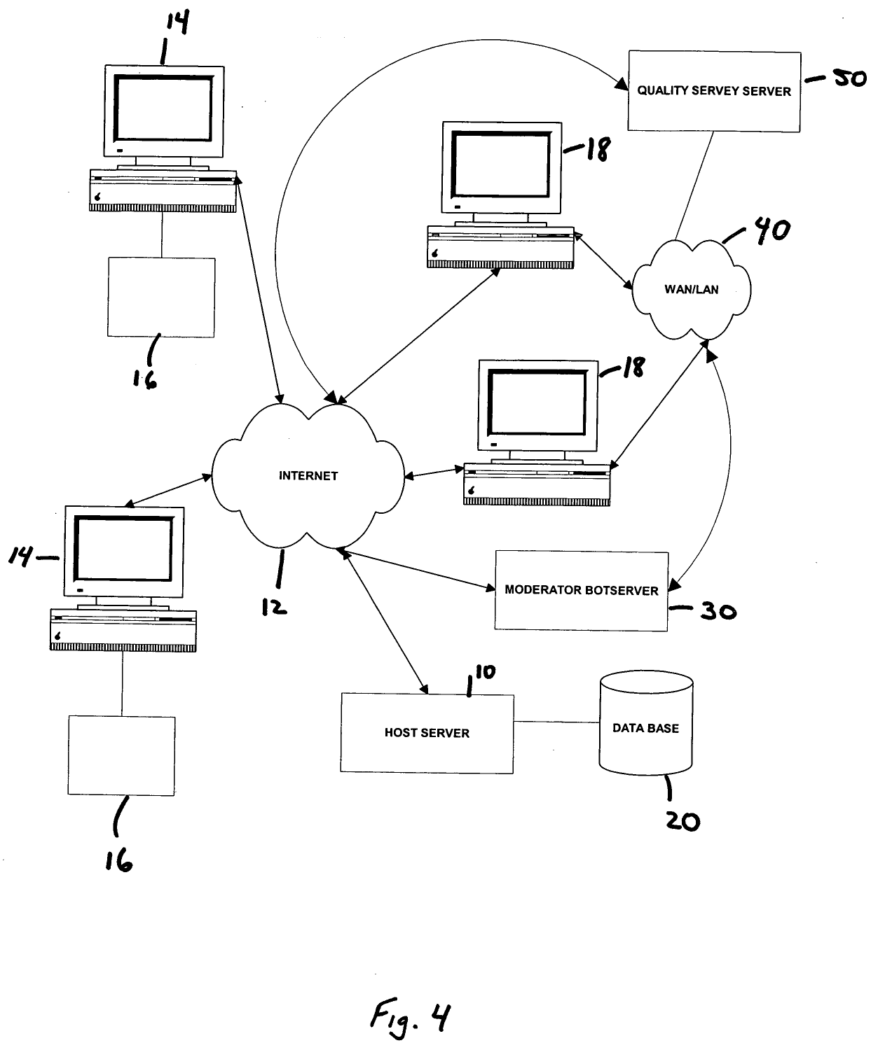

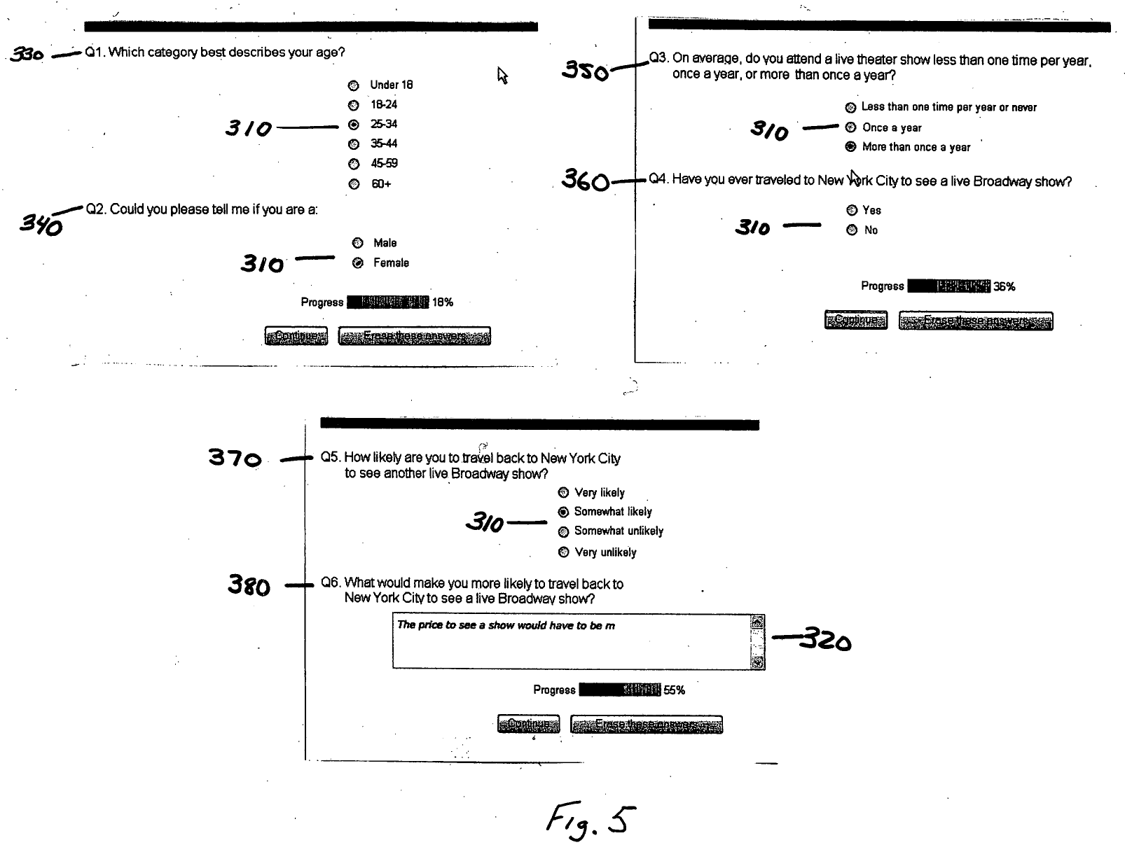

Respondent participation in on-line surveys is a form of communication that leads to the retrieval of data, step 105, such as from the database 20 (FIG. 4), which serves to identify respondents deemed qualified to participate in the individualized interviews, also known as one-on-one qualitative sessions. For instance, a client can pre-select criteria for respondents to meet in order to qualify to engage in a qualitative session. The client's pre-selected criteria would be stored in the database 20 and a data analysis module can be configured to monitor respondents responses in the quantitative session and determine if a match has been made with the pre-selected criteria. For instance, the client may wan to gather information from dog owners, and can choose to qualify anyone who answers “yes” to the question “do you own a dog” that they request appears in the quantitative session. Equivalently, the client may choose to qualify anyone who is female, 27 years old and attends live theater more than once a year (See FIG. 5). The data analysis module would monitor the respondents' responses and would contain instructions operable to interrupt the quantitative session, once the pre-selected criteria has been matched. The necessary qualifications, step 110, can be randomly determined or can be based on pre-selected or real-time criteria. The pre-selected and real-time criteria concepts are further discussed in conjunction with “pre-project programming”. If a respondent does not meet the qualification criteria for an individualized interview, the respondent simply continues with the on-line survey, step 113, as is conventional. However, if a respondent is deemed qualified, in accordance with a salient aspect of the invention, the respondent is redirected to a qualitative one-on-one session, step 115. Preferably, qualified respondents will receive on-screen notifications indicating that they are now being connected to a live moderator to answer additional in-depth questions (See FIG. 2). The redirection of a respondent, and thus the initiation of an individualized interview can occur at any point in the survey that client prefers. Clients' preferences are reflected in their selection of the qualification criteria, and the determination at step 110 is made when requisite data stored by the system for the client has been gathered, e.g., after the respondent answers “yes” to questions 1, 2, 5 and 8.

In an aspect of the invention, pre-project programming can be used in conjunction with quantitative on-line surveys. In accordance with this aspect, the criteria for the candidates to be selected from the demographic pool and included in the individualized interviews from the overall sample can be either predetermined or discovered. A panel company supplying the sample or the client can pre-select the types of individuals they would like to include in the individualized sessions, for instance by qualifying all 30 year old females that enjoy ballet. All individuals matching such criteria would then be redirected to an individualized session, step 115. Alternatively or in addition, qualified individuals can be discovered during the quantitative portion of the research, for example as a result of a logical process of monitoring responses to particular answers in the survey, i.e. all individuals that answer in the affirmative to question twelve will be deemed qualified and thus redirected to an individualized session, step 115. These criteria may be mixed, matched and chained together to produce a second-level sample that is optimal for the project's purposes or to produce a second-level sample of individual qualitative data of a minimum size. As previously discussed, the data analysis module monitors respondents' responses and contains instructions operable to interrupt quantitative sessions, once the pre-selected criteria has been matched. Additionally, and in contrast to the predetermined or discovered concepts, qualification may occur through random selection, which will also cause a redirection to an individualized session, step 115.

The individualized interviews occur after redirecting a respondent from an on-line survey to a chat session with a live moderator. The moderator can be stationed anywhere in the world, or can be a bot that executes from a server 30 (FIG. 4) located remote from the respondent. More generally, live moderators and bots are referred to herein as “moderators.” The terms “directed” and “redirected” refer to presenting a qualified respondent with an individualized session. The term “chat session” refers to the type of sessions that can be conducted through a number of software products, such as sessions that are conducted by typing using a messenger such as Yahoo! Messenger, Microsoft Messenger, AOL Instant Messenger or programs operating in a similar manner. Generally, the one-on-one chat sessions last approximately eight to twelve minutes, and are designed to elicit qualitative information. Through the use of such sessions, moderators are enabled to gather valuable information from a pool of (preferably qualified) on-line survey respondents that serves to inform the client and enhance its overall market research strategy. Furthermore, the one-on-one environment offers respondent's anonymity in a pressure free setting, creating an atmosphere that generates a genuine dialogue and spawns an uninhibited flow of participant reactions, thoughts, and emotions. As previously described, such individualized interviews can be launched at any point in the survey depending on the client's selection of the qualification criteria, which usually reflects the client's goals and objectives.

As previously discussed, redirection of a qualified respondent refers to either an automatic push of a qualified respondent to an individualized session or to an invitation to a qualified respondent to participate in an individualized session. The data analysis module contains instructions operable to interrupt quantitative sessions, and contains instructions that define the interruption as a push or an invitation. In connection with a push, the data analysis module interrupts an active quantitative session and automatically directs a qualified respondent to a one-on-one session. A qualified respondent is not given a choice whether to participate in a one-on-one session. In connection with an invitation, the data analysis module sends an invitation to a qualified respondent asking them to participate in a one-on-one session. In the invitation option, a qualified respondent can reject to participate in a one-on-one session and can simply continue taking the quantitative session. Both the push and the invitation, can be based on the matching of pre-determined criteria or discovered criteria, or through random selection. In one implementation, code is embedded within a program which pushes the respondent into a chat session by redirecting the user to a particular web page (e.g., provided by the host server 10 or the qualitative survey server 50) or by displaying within a frame of a presently displayed window a chat session interface (e.g. provided by a server as noted above). If the chat session is displayed as a framed-window, the individual interview would appear as an embedded window on a Data Collection Company's site. The actual location of the window on the screen, along with the layout of the content, such as the text or graphics is a matter of user preference and can be defined in the administrative set up for each project. Alternatively, if a respondent is redirected to a separate web page, the redirection link to be used is preferably defined in the administrative set-up for each project. Preferably, the push enabling code includes instructions that test the criteria as described above before interrupting the flow of the survey and the delivery of any remaining questions in the survey to the respondent.

The code can be configured to present an invitation to the survey respondent to participate in the chat session before the push. If the survey is written in HTML, the code can be embedded in the HTML, e.g., as including, HTML, DHTML, XML, JavaScript, Applet, ActiveX, C++ or other languages that permit operations to be performed on the client or server side of the interview session. The code preferably contains the instructions necessary to route the second-level sample to the individualized interview session. The code used to launch the respondent into a chat session preferably imports data directly from the underlying quantitative interview into the chat session in a way that makes survey responses and/or demographic information about the respondent available to the moderator, such as for display on a terminal used by the moderator (see FIG. 3 element 200) or in a data file accessible by a bot-moderator, for use during the interview session. The importation of data provides a user “snapshot”, and is further discussed below.

In a preferred form, the code operates to direct respondents who qualify for the individualized interview session to the chat session interface during the course of the on-line survey. As noted above, the chat session interface can appear as a framed-window hosted by the on-line survey site, or it can be provided due to a re-direct to a web location hosted by a different entity than the on-line survey provider. The respondent engages in a real-time question and answer session with the moderator. Once a respondent has been redirected from the quantitative survey and is connected to the moderator, the respondent sees an interactive dialogue box, which can take a variety of forms, including such as depicted in FIGS. 2 and 7. The interactive dialogue box is preferably an interview window that appears on each of the moderator's and respondent's computer screens, and allows the commencement of the question and answer session. The instruction text on the respondent's and the moderator's screens can be defined in the administrative setup for each project. In a preferred form, the chat application does not require the respondent to download additional software and thus comprises a peer-to-peer message transfer program.

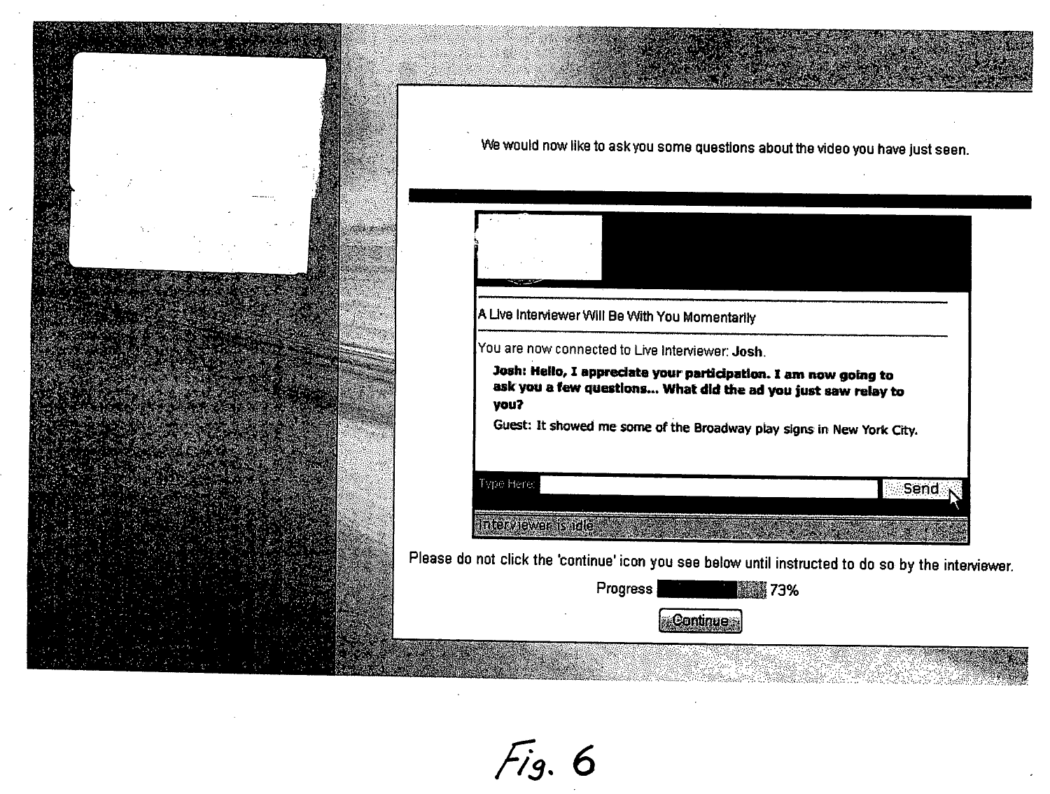

Once the respondent is redirected to a chat session, step 125 (See FIG. 6), the availability of a moderator is assessed, step 120, e.g., by the qualitative survey server 50 or by a module executing at the host server 10. The availability of a human moderator can be determined through processes or queries performed through the Internet 12 or through a WAN/LAN 40 that connects the qualitative survey server 50 to the modulator machines 18 and to the moderator bot server 30. If the moderator is available and chooses to accept the chat, the moderator can become immediately privy to a user profile 200 (FIG. 3) that preferably appears on the moderator's screen. A user profile, also known as a user snapshot 200 is presented in the moderator's screen and includes information about the respondent to aid the moderator in conducting personalized and targeted sessions with each respondent. The user snapshot can be created from the participant's demographic data, from answers to questions or from information provided in a database about the respondent, as well as the respondent's answers to attitudinal and behavioral questions obtained in the survey. When the moderator is a bot, this information need only be available, if at all, in a data file. The user snap shot can consist of and be designed in anyway the client prefers. For instance, user snapshot questions can be predetermined in discussions with the individual interview session staff or the client, and can be single responses, multiple responses, open ended responses or a calculated number of responses. In providing the moderators with information regarding specific respondents, the user snapshot replaces warm-up scenarios that generally start one-on-one interviews and are also typical in focus group style interviews. Additionally, snapshots give participants a sense of importance, as their recent thoughts and opinions play an essential role in the conversation, and thus facilitate uninhibited conversations. Operating instructions can be configured to import the user profiles of the respondents to the chat sessions and display such to the moderator. If a re-direct link to another location is used instead of a framed window inside the on-line survey hosts site, variables to be used in a user snapshot can be passed to the server of the entity conducting the individual interview. Optionally, a data translation module can be configured to select among variables in the user snapshot and use that data to populate opened ended questions. Data translation module definitions can be setup in the administrative module. For example, if the user answers “yes” to a question about owning a pet and selects “Dog” as the type of pet, the data translation module can compose a question such as what do you feed your DOG, when DOG is pulled from the respondent's online survey responses.

A host of additional features can be made available to moderators. In one implementation, moderators have the ability to create prepared questions, before a project launches, to save time from typing introductory or repetitive questions during the session. Specifically, moderators can enter and program project specific canned responses 210 (FIG. 3) in the moderator administration module, or can import canned responses 210 from previous projects. Canned commands 220 can also be available for moderator use to initiate a process on the user's screen. Processes can include pushing a URL (which opens an additional window with a webpage on the interviewer's screen), opening e-mail to an address of the respondent, providing a hyperlink, pushing an image, sound byte, video, document/excel/powerpoint to facilitate discussion with the respondent. Additionally, user interfaces can include status indicators, which are real-time viewable typing functions allowing moderators and respondents know when the other party is typing or idle. A time display 230 that indicates the lapsed time of a qualitative session can also be presented through the interface. Moreover, a Do Not Save feature can be made available to a moderator, allowing moderators not to save sessions. Although all sessions are preferably saved in real time, the Do Not Save feature can prevent that session from counting towards the overall and subgroup quotas (which can be preset by the client). Optionally, an answer-time indicator can be provided to show the length of time it takes the respondent to answer a question. All the various features can be defined in the administrative setup for each project, and can be individualized depending on the goals of a specific client. A client administrative module can be configured to allow for the input of individualized client information into a software database. Similarly, a job administrative module can be configured to store client specific job description information. Furthermore, code can be configured to restrict qualified applicant's from terminating in-progress chat sessions, e.g., by rendering a continue 240 button inoperable until the moderator sends a signal to the client's machine 14.

In another aspect of the invention, moderators can be unavailable or can choose to decline sessions from qualified respondents who have been redirected from a survey to an individualized chat session. Under such circumstances respondents can receive bridge messages indicating moderator unavailability and directing the respondent to hit the continue button 240 (FIG. 2). The continue button 240 can be available at the bottom of the screen and can be used to allow respondents to continue with a quantitative on-line survey. Moderator unavailability can result from a moderator declining a session or for various other reasons, including if a moderator is not signed into a particular project or if a moderator is conducting more than a prescribed number of qualitative sessions at the same time. An administrative module can be configured to determine the number of in-progress chat sessions of a particular moderator, and to designate a moderator unavailable if that number is exceeded.

In connection with gathering information from suitable respondents, it is desirable to collect both qualitative and quantitative information. As described herein, qualifying respondents are identified and solicited to participate in a quantitative survey; however, the present inventors have recognized that many online surveys are not completed, which means that a suitable respondent may only provide answers to a portion of all of the questions in the survey. Accordingly, it is desirable to identify early in the quantitative survey whether a suitable respondent satisfies other criteria that have been established in order to invite such respondent into a chat session in order to obtain qualitative information.

The criteria for determining whether a particular respondent is suitable for directing into a moderated chat session is preferably based on answers provided to one or more of the quantitative survey questions. For example, one of the early questions in the survey can be formulated so as to identify most desired prospects for moderated sessions. Equivalently, the criteria can include a review of several answers provided by the respondent to determine whether the combined set of answers satisfy the criteria for the moderator chat session. For instance, if a client wanted to qualify 27 year old females that attend live theater more than once a year, the quantitative survey would include questions formulated to address such issues. For example, FIG. 5 depicts questions that can be presented to audience members during such quantitative surveys. The quantitative surveys are interactive, and can appear in various forms. For instance, the quantitative survey can present questions to respondents with various pre-defined multiple choice answers 310. The quantitative surveys can also present open dialogue boxes 320 for supplying answers, or the quantitative surveys can consist of a combination of both.

As described herein, the qualifying respondent is directed to a chat session in which qualitative information is collected. The qualitative information and the questions that are presented during chat session can be driven, in part, by the particular responses from the quantitative survey conducted so far. At the conclusion of the qualitative survey, a determination is made as to where to direct the respondent with regard to the remaining, yet unanswered, questions of the quantitative survey. The determination as to where to place the respondent in the online survey can be to return the respondent at the point in the survey from which the respondent was originally redirected to the online chat, or the return point to the online survey can be a function of the prior answers provided in the quantitative survey, alone or in conjunction with the qualitative responses that were gathered and stored in connection with the qualitative survey. Further, given that respondents do not always complete such surveys, the remaining questions in the quantitative survey can be rearranged so as to place those questions which have the highest priority to the survey creator earlier than the remaining questions. For instance, if in FIG. 5 a respondent answers questions one through three (See FIG. 5, 330-350) and that qualifies them into a one-on-one live chat session, the respondent will be redirected to a live session and will engage in a conversation with a moderator, as seen in FIG. 6. The respondent will answer the moderators questions, until the moderator has gathered the desired information, at which point the respondent can be re-directed to the quantitative survey. Since, the respondent has already answered questions one through three the respondent can be returned to the quantitative survey at question four (See FIG. 5, 360). The respondent can also be returned to a completely different question; for instance, the previous answers provided in the quantitative survey can be evaluated alone or in conjunction with information received from the qualitative survey and a determination can be made as to which point in the quantitative survey to return the respondent, e.g. question 6, 320.

All of the foregoing determinations are made with the assistance of either the host server 10 or another server such as the qualitative survey server 50 with reference to data that has been captured and stored in the course of the quantitative and qualitative surveys. Processors within the servers are programmed and connected so as to have access to this information as well as to rules that govern the criteria for these determinations and analyses. The rules and their settings can be established with regard to the administrative setup of any given project (that is, any given quantitative or qualitative survey).

Referring again to FIG. 1, as aforementioned, at the conclusion of an interview, respondents can be passed back to the host site to resume the quantitative survey from the point in which they were redirected into an individualized interview or from an alternative point, step 130. Upon completion of the qualitative session, the respondents is preferably or can be presented with a customized survey in which the further survey questions have been selected on the basis of data gathered from the qualitative interview instructed to continue the survey, so that additional quantitative data can be gathered. In an aspect of the invention, opportunities are provided for clients to extract and formalize the information revealed in quantitative and qualitative sessions, which can be recorded and observed subsequent to the interview's conclusion. For instance, quantitative and qualitative data from each interview can be categorized and analyzed, and the outcome can be reported to the client. The system can be configured to provide clients with complete memos analyzing the qualitative learning, including major findings and recommendations the analysis can be statistical in nature, using programmed formulas and comparisons to other data or benchmarks. Representative verbatim responses from the individualized sessions can be forwarded to the client in reports to the client. The gathered analysis can be utilized as a stand-alone product or in conjunction with the data received from the quantitative research firm conducting the study. As an additional option, transcripts of the individualized chat sessions can be created and exported to accommodate separated values. By way of example, transcripts can be exported to excel to enable the reporting and filtering of chats according to various features, such as variables of a user snapshot, durations of sessions, time of capturing the sessions, the saved or disregarded status of the sessions, or verbatim transcripts of chats. The transcripts can be viewed by moderators, clients or panel companies on screen or in hardcopy form. A quality control module can also be provided to allow the viewing of chat session in real-time. As a safety precaution, jobs and projects can be password protected.

In an additional aspect of the invention, the redirection to a chat session, including invitations and pushes can be coordinated with quotas or other criteria set by a given client. For instance, an overall or a subgroup quota for qualitative sessions can be defined in the administrative setup of the project. By way of example, if a client were to define specific quotas on how many completed sessions are to be captured that satisfy specific variables (e.g., 10 complete surveys of 18 to 24 year old males, 15 female completes and 30 completes of men who answered affirmative to question 3), then the criteria for invitations and pushes into chat sessions can be modulated using the dynamic data being captured in the survey so as to ensure that goals for completed surveys are satisfied. The client can have numerous options in selecting the quota module features in the administration module. For instance, the client can define an overall quota for all completed sessions. The client can also define specific quotas on completed sessions among imported variables, e.g. 10 male completes and 30 female completes. The client can also define specific quotas on completed sessions using multiple imported variables e.g., 18-24 year old males 10 completes and 25-30 year old males 30 completes. This can allow the client maximum flexibility of the demographics of the respondents, which can provide the most targeted qualitative analysis. Furthermore, if a predefined quota is reached for a particular subgroup or for the overall number of qualitative sessions, respondents can receive bridge messages and be instructed to hit the continue button to continue with the quantitative survey or not be redirected to a chat session at all. Gathered information is optionally reported to the client in accordance with each defined quota group. Staff conducting individualized interviews or software managing all of the moderators can keep count of overall samples by subgroup. Additionally, a filtering tool can be provided to filter reports by date and time. For instance, the client may select to receive a report of quotas on March 11^{th} between 3 p.m. and 5 p.m. All quota definitions can be changed in real time.

In determining quotas it is possible to select certain types of sessions to exclude from the count towards the quota. For instance, a missed session where moderators are unavailable or have declined to conduct individualized sessions can be excluded. Similarly, unsaved sessions or individualized sessions occurring after a quota has been reached can be excluded from the count reported to the client.

The quantitative on-line surveys and the qualitative one-on-one chat session can be conducted by the same or difference entities. In instances where the quantitative surveys and the qualitative sessions are conducted by different parties a form of cooperative interaction preferably exists. The party conducting the qualitative interview can gather information either from a server side rule based system or from client side active programs.

A combination of Internet technology and communications systems can provide the infrastructure to support the processes described above. FIG. 4, depicts a communication network environment suitable for implementing the present invention. This network environment includes a host server 10 connected to a communication network, e.g., the Internet 12 to contact various multimedia computers 14. The multimedia computers 14 can include bidirectional audio/visual capability, e.g. speakers, microphone or video camera. Optionally, connected to the multimedia computers are an electronic whiteboard, tablet, or other device 16 that permits interactive document creation, viewing, and mark-up across the communication network. The multimedia computers 14 are provided at remote locations accessible to respondents, and moderators can be provided with similar machines 18, although a moderator terminal can omit a video camera and/or electronic whiteboards/tablets.

The host server 10 provides a user interface, such as a Web page(s), using some Internet facility such as the World Wide Web. See, for example, FIG. 2, which illustrates a chat session interface.

Thus, while there have been shown, described, and pointed out fundamental novel features of the invention as applied to several embodiments, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

We claim:

1. A method for collecting information in real-time during an on-line survey being conducted through a network with one or more client devices, comprising the steps of:
soliciting an audience for participation in an on-line survey;
obtaining data communicated from the audience through the network from the client devices during the on-line survey;
in response to the communicated data, selecting from the audience qualified respondents for a one-on-one real-time chat session;
directing the client devices of the qualified respondents into communication with a moderator of the chat session; and
collecting information through the network from the client devices of the qualified respondents during the chat session with the moderator.

2. The method of claim 1, including the additional step of presenting the chat session at the client devices so as to restrict the qualified respondent's from terminating an in-progress chat session.

3. The method of claim 1, including the additional step of displaying a user profile to the moderator during the chat session with a qualified respondent.

4. The method of claim 1, including the additional step of storing the information collected from each chat session.

5. The method of claim 1, including the additional step of reporting the chat session to a client.

6. The method of claim 5, wherein the reporting step occurs in real-time.

7. The method of claim 1, including the additional step of redirecting the qualified respondents from the chat session to the on-line survey.

8. The method of claim 1, including the additional step of conditioning the directing step upon availability of the moderators.

9. The method of claim 8, wherein there is a set of available moderators, the method including the additional step of performing load balancing among the moderators in the set.

10. The method of claim 8, including the additional step of sending a bridge message over the network to the client device of the qualified respondent when the moderator is unavailable.

11. The method of claim 1, including the additional steps of providing the moderator with an array of prescribed responses and configuring a moderator device to communicate one or more prescribed responses to a particular client device.

12. A system for collecting information in real-time during an on-line survey, said system comprising:
a communication network;
a server connected to the communication network and configured to interface with a client computer accessed by a respondent;
an accumulator module associated with the server and configured to accumulate any responses received from the respondents and to match the responses to a predetermined set of responses; and
operating instructions, executing in the server and configured to interrupt a real-time on-line survey and to direct respondents to a one-on-one real-time chat session in response to any matches by the accumulator module.

13. The system of claim 12, further comprising a control module configured to restrict the qualified respondent from terminating an in-progress chat session.

14. The system of claim 12, wherein the server acts as a host for the on-line survey, further comprising a direction module configured to present the chat session as a framed window within the on-line survey.

15. The system of claim 12, wherein the server acts as a host for the on-line survey, further comprising a direction module configured to redirect the chat session to a location outside of the on-line survey.

16. The system of claim 12, wherein the operating instructions are configured to test any responses received from the accumulator module prior to interrupting the survey.

17. The system of claim 12, wherein the operating instructions are configured to import a user profile of the respondent to the chat session, communicate the user profile to the moderator, and display the user profile to the moderator.

18. The system of claim 12, including an administrative module configured to determine the number of in-progress chat sessions of a particular moderator.

19. A system for enabling live chat sessions during on-line surveys, comprising the steps of:
a communication network including a server configured to distribute the on-line surveys;
a system computer, accessible to at least one moderator;
a client computer accessible to at least one respondent;
a module for selecting from an audience of respondents at respective client computers at least one qualified respondent for a one-on-one real-time chat session;
a set of instructions executing on the server and operable to direct the qualified respondents into respective chat sessions with one or more of the moderators; and
a communication link between the system computer of one of the moderators and the client computer of at least one qualified respondent.

20. A method for enabling a live chat session during an on-line survey, comprising the steps of:
providing the survey to a pool of respondents over a distributed network, the survey including active code;
establishing predetermined criteria for selecting respondents who have interacted with the survey for direction to the chat session;
interacting with the respondents to the survey using displayable interactive components;
monitoring any interactions by the respondents with the interactive components to determine if the interactions satisfy a criterion; and
directing respondents whose interactions satisfy the criterion to the chat session.
